(19) United States
(12) Patent Application Publication
(10) Pub. No.: US 2023/0048645 A1
(43) Pub. Date: Feb. 16, 2023

(54) INSTANTLY DEPLOYABLE SELF SUPPORTING VEHICLE AWNING

(71) Applicant: Kammok Holdings, LLC, Austin, TX (US)

(72) Inventors: Sean Leese, Austin, TX (US); Greg McEvilly, Austin, TX (US); Chris Eddy, Austin, TX (US); Henry Parker, Austin, TX (US)

(73) Assignee: Kammok Holdings, LLC, Austin, TX (US)

(21) Appl. No.: 17/885,482

(22) Filed: Aug. 10, 2022

Related U.S. Application Data
(60) Provisional application No. 63/231,413, filed on Aug. 10, 2021.

(51) Int. Cl. E04F 10/06; E04H 15/06

(52) U.S. Cl. CPC E04F 10/0603; E04F 10/0692; E04H 15/06

(57) ABSTRACT

An awning includes an awning body. The awning body may include a reel, an awning canopy, a first swing arm, a second swing arm, and an endbar. The awning cover may be disposed between the reel and the endbar when the endbar is extended away from the awning body by the first swing arm and the second swing arm.

### BACKGROUND

This application claims the benefit of U.S. Provisional Application No. 63/231,413, filed Aug. 10, 2021, which is incorporated herein by reference in its entirety, including but not limited to those portions that specifically appear hereinafter, the incorporation by reference being made with the following exception: In the event that any portion of the above-referenced provisional application is inconsistent with this application, this application supersedes said above-referenced provisional application.

Car campers and all types of outdoor users who use their vehicles to access the outdoors have come to rely on their vehicles as a basecamp for getting prepped and dressed for adventure, cooking, repairing outdoor gear, or just resting in between adventures.

Most vehicles only offer tight internal space, not suitable for these activities. The rear door of hatchback and SUV type vehicles sometimes offers overhead shelter for those standing under, but shelter space is very limited.

Attempts to address this problem led to the development of awnings for mounting to the top of a vehicle’s roof rack as at least partial support for holding up one side of the awning. However, existing car awnings are time consuming and cumbersome to deploy, especially for a single user. While suitable for campers who will leave their vehicle in place, and therefore will leave the awning up for an extended period of time; these designs are not suitable for users who might wish to use them for short time periods such as getting dressed.

Because existing car awnings are time consuming to deploy, making them unsuitable for short term uses, there is a need for a quickly deployable self-supporting car mounted awning.

### SUMMARY

An awning includes an awning body. The awning body may include a reel, an awning canopy, a first swing arm, a second swing arm, and an endbar. The awning cover may be disposed between the reel and the endbar when the endbar is extended away from the awning body by the first swing arm and the second swing arm.

### BRIEF DESCRIPTION OF THE DRAWINGS

These and other features, aspects, and advantages of the disclosed embodiments will become better understood with regard to the following description, appended claims, and accompanying drawings:

FIG. 1 illustrates an isometric view of one version of an embodiment of a self-supporting awning in a closed position.

FIG. 2 illustrates an isometric view of a self-supporting awning in a partially opened position.

FIG. 3 illustrates an isometric view of one version of an embodiment of a self-supporting awning in an open position.

FIG. 4 illustrates a left side view of one version of an embodiment of a self-supporting awning including a supporting mount.

FIG. 5 illustrates an isometric view of a self-supporting awning including supporting mounts.

FIG. 6 illustrates an isometric view of the self-supporting awning including a supporting mount.

FIG. 7 illustrates a cross sectional view of the self-supporting awning and a support mount.

FIG. 8 illustrates an end of the self-supporting awning and tensioning mechanism.

FIG. 9 illustrates a side view of the self-supporting awning in a tensioned position.

FIG. 10 illustrates a side view of a self-supporting awning tensioning mechanism in a locked position.

FIG. 11 illustrates an isometric view of another end of the self-supporting awning assembly and retraction mechanism.

FIG. 12 illustrates a side view of a retraction mechanism within the self-supporting awning assembly.

### DETAILED DESCRIPTION

As used herein, the term “assembly” refers to a collection of individual parts or elements that have been fixed together either rigidly or into a pivoting, sliding, or other configuration such that they cannot be readily separated from each other. The term “whole assembly” is used to refer to the version of the awning in its entirety. The term “sub assembly” refers to an “assembly” as defined previously, that is a part of the whole assembly; these sub-assemblies are labeled in illustration with a box around the collection of parts making up the sub assembly.

Unless otherwise stated, all technical terms have the same meaning as commonly understood by one with ordinary skill in the art to which this awning belongs; all non-technical terms have the same meaning as commonly understood in general discussion and should not be strictly interpreted as their dictionary definition.

In reading the following description various alternative design embodiments for different elements of the awning and combinations of these elements will be discussed. The description will not list every possible combination of these alternative elements, nevertheless the specification and claims should be read with the understanding that these combinations are within the scope of the disclosure and the claims.

It should also be understood while reading the following disclosure that if the material of a piece is not explicitly specified or options discussed in passage, that the material is not important and that the use of any material for the element is within the scope of the disclosure and the claims.

Not every element of the awning is described within this document. Any element not described which may or may not be shown in figures should be understood to be an aesthetic piece or one that is otherwise not important to the utility of the disclosure.

Examples and embodiments of the instantly deployable self-supporting vehicle awning are described herein. The following disclosure is not intended to limit the disclosure to the embodiment illustrated in figures or to embodiments described below.

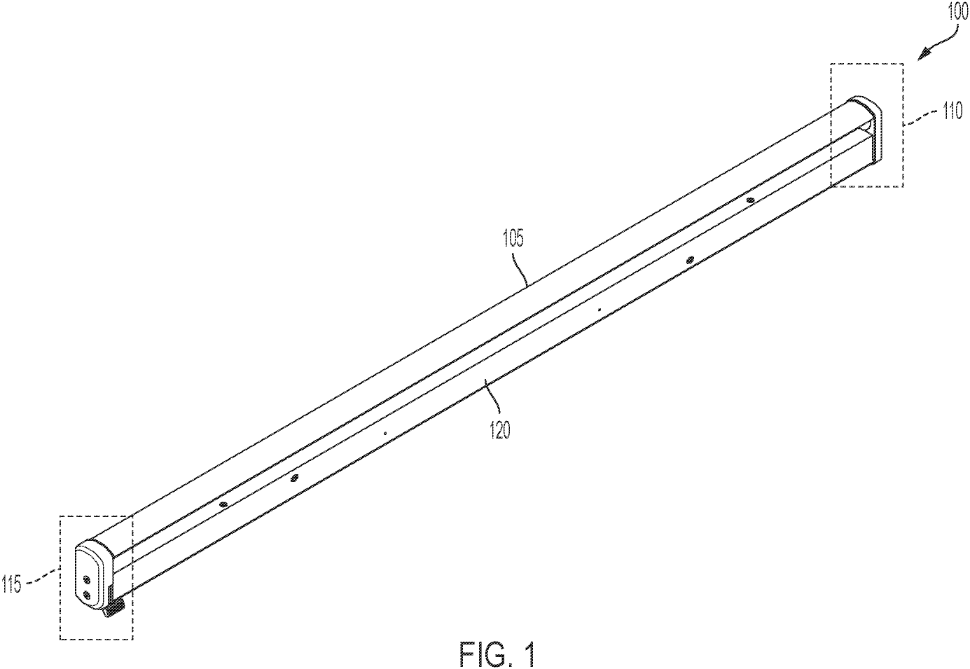

FIG. 1 illustrates a self-supporting awning 100. Self-supporting awning 100, as shown in FIG. 1 is disposed in a closed position. Self-supporting awning 100 includes a body 105, a reel system 110, a tensioning and locking system 115, and an endbar 120. Self-supporting awning body 105 and endbar 120 may be constructed using a metal, composite, or plastic material, with sufficient resilience to withstand the stresses of being attached to a rack on a vehicle, for example. As will be discussed below, an awning cover or canopy (not shown in FIG. 1) may be contained within body 105. The awning cover or canopy may be extended from when endbar 120 is extended away from awning body 105 and retracted back into body 105 when endbar 120 is retracted back into the closed position for self-supporting awning 100, shown in FIG. 1.

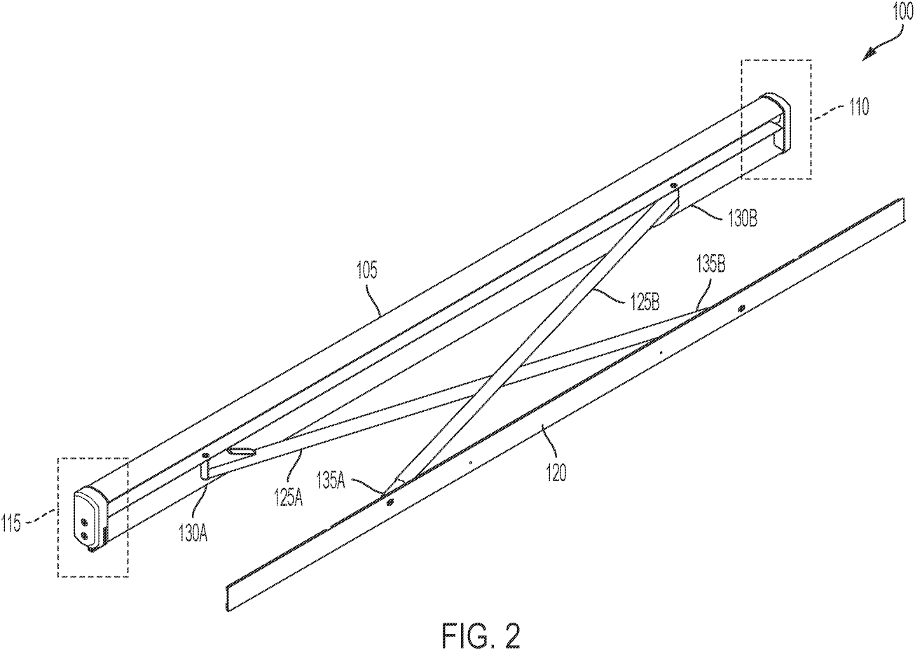

FIG. 2 illustrates an isometric view of self-supporting awning 100 in a partially opened position. As shown in FIG. 2, self-supporting awning 100 includes body 105, a reel system 110, a tensioning and locking system 115, and an endbar 120. Self-supporting awning 100 is shown in a partially open position. For example, a user may pull on endbar 120 which extends first swing arm 125A and second swing arm 125B from body 105. First swing arm 125A and second swing arm 125B may also be constructed using materials similar to body 105, such as a metal, a composite, or a plastic material First swing arm may be connected to body 105 at pivot point 130A and to endbar 120 at pivot point 135B. Second swing arm 125B may be connected to body 105 at pivot point 130B and to endbar 120 at pivot point 135B. Pivot points 130A, 130B, 135A, and 135B may be connection points between body 105 and endbar 120 for first and second swing arms 125A and 125B. Pivot points 130A, 130B, 135A, and 135B may be fashioned by rivets or bolts or any connector known to those of ordinary skill in the art to allow swing arms 125A and 125B to pivot as the end bar is extended away from body 105.

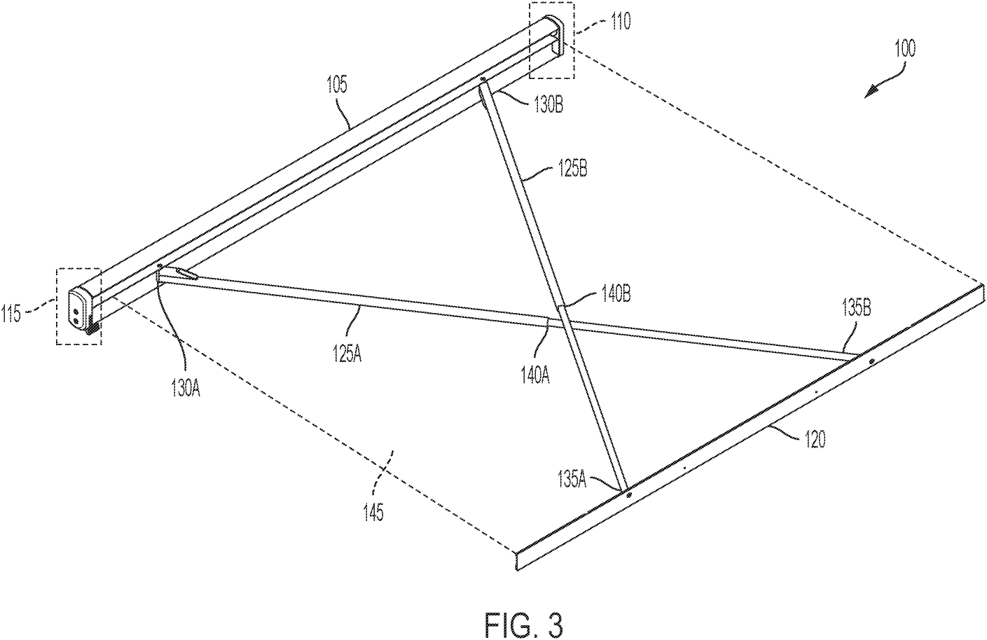

FIG. 3 illustrates an isometric view of one version of an embodiment of a self-supporting awning 100 in an open position. As shown in FIG. 3, self-supporting awning 100 includes body 105, a reel system 110, a tensioning and locking system 115, and an endbar 120. Self-supporting awning 100 is shown in a fully open position. For example, a user may pull on endbar 120 which extends first swing arm 125A and second swing arm 125B which are folded into body 105 from body 105. First swing arm 125A and second swing arm 125B may also be constructed using a material similar to body 105, such as a metal, a composite, or a plastic material First swing arm 125A may be connected to body 105 at pivot point 130A and to endbar 120 at pivot point 135B. Second swing arm may be connected to body 105 at pivot point 130B and to endbar 120 at pivot point 135B. Pivot points 130A, 130B, 135A, and 135B may be connection points between body 105 and endbar 120 for first and second swing arms 125A and 125B. Pivot points 130A, 130B, 135A, and 135B may be fashioned by rivets or bolts or any connector known to those of ordinary skill in the art to allow swing arms 125A and 125B to pivot as the end bar is extended away from body 105.

As endbar 120 extends away from body 105, swing arms 125A and 125B may include telescoping portions, such as telescoping portion 140A of first swing arm 125A and telescoping portion 140B of second swing arm 125B. As shown in FIG. 3, endbar 120 is extended to full extension in an open configuration in contract with FIG. 2, which showed self-supporting awning 100 in a partially open position. At a certain point of extension, telescoping portions 140A and 140B of their respective swing arms extend to full extension, in cooperation with pivot points 130A, 130B, 135A, and 135B to allow endbar 120 to reach maximum extension.

It is also noted that, as shown in FIG. 3, second swing arm bar 125A is disposed over top of second swing arm bar 125A to allow extension of swing arm bars 125A and 125B without swing arm bars 125A and 125B restricting or impeding each other’s movement. First swing arm bar 125A may also be disposed under second swing arm bar 125A, interchangeably. First swing arm bar 125A and second swing arm 125B may cross each other at approximately 90 degrees (plus or minus 5 degrees) when fully deployed, as shown in FIG. 3.

FIG. 3 further illustrates an awning covering or canopy 145 which is attached within body 105 and to endbar 120. Awning covering or canopy 145 may be constructed from any type of fabric, including vinyl, nylon, plastic fabrics, and any other material known to those of ordinary skill in the art. Awning covering may be selectively connected by use of hook and loop tape, snaps, or other connections known to those of ordinary skill in the art. Further, the covering or canopy 145 may be detachable from the rest of awning 100.

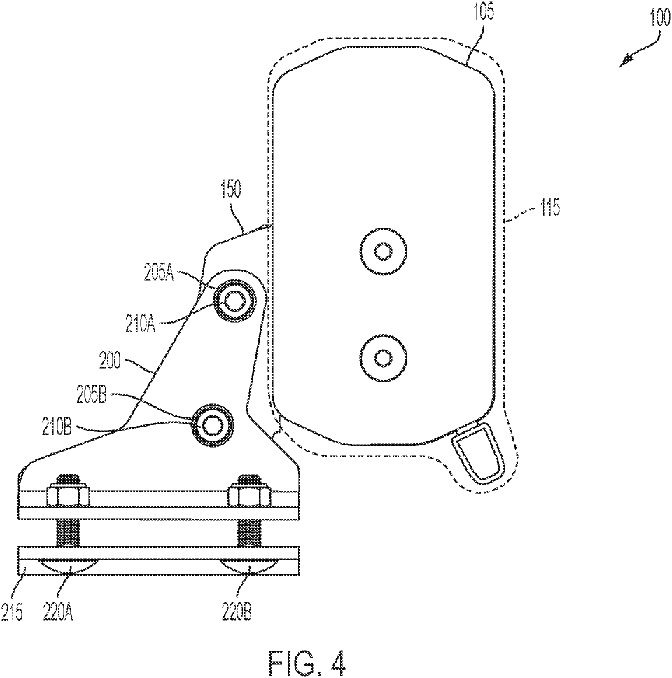

FIG. 4 illustrates a left side view of one version of an embodiment of a self-supporting awning 100 including a supporting mount 150 attaching to a support body 200. Self-supporting awning 100 may include supporting mount 150 which, when connected to support body 200, provides support for self-supporting awning 100 when endbar 120 is fully extended from body 105. Support body 200 may attach to a rack or a roof rack on a vehicle, or any other location, such as the side of a recreational vehicle, or anywhere clamp 215 may clamp a solid structure between clamp 215 and support body 200. Supporting mount 150 and support body 200 are shown from a left side view of self-supporting awning 100, body 100, and tensioning and locking system 115.

As shown in FIG. 4, Support body 200 includes holes 205A and 205B which may receive bolts 210A and 210B. Bolts 210A and 210B may be used to connect support body 200 to supporting mount 150 on body 105 of self-supporting awning 100. Clamp 215 may be further connected to support body 200 via bolts 220A and 220B which secure clamp 215 to support body 200 with the intent that clamp 215 may squeeze a structure, such as a roof rack, tightly enough that a firm connection between support body 200 and clamp 215 may be established.

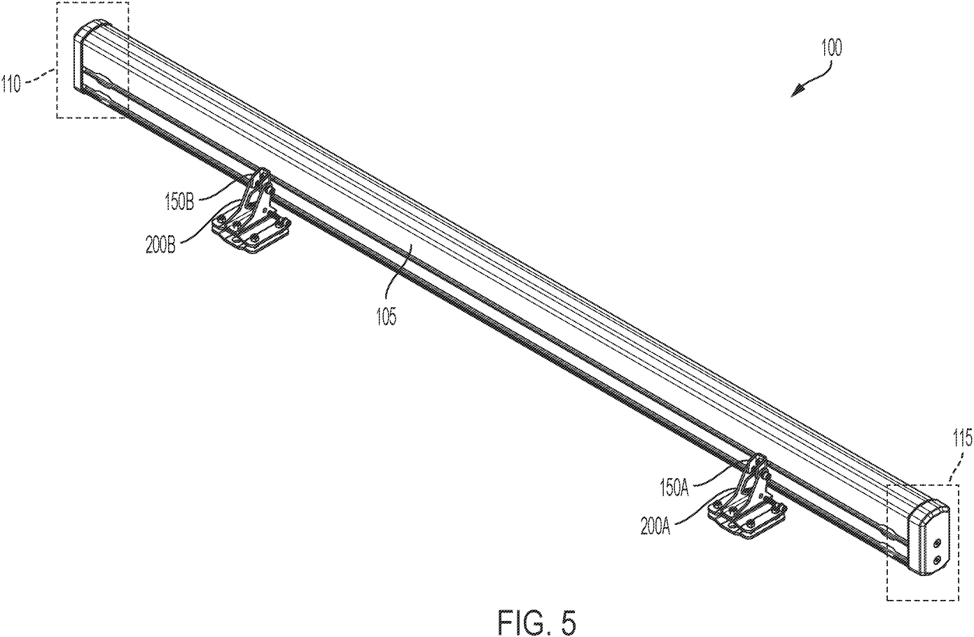

FIG. 5 illustrates an isometric view of a self-supporting awning 100 including supporting mounts 200A and 200B. As shown in FIG. 5, self-supporting awning 100 includes body 105, a reel system 110, a tensioning and locking system 115, a first supporting mount 150A connected to support body 200A, and a second supporting mount 150B connected to support body 200B. FIG. 5 illustrates that one, two, or more supporting mounts 150 and corresponding support bodies 200 may be implemented on self-supporting awning 100.

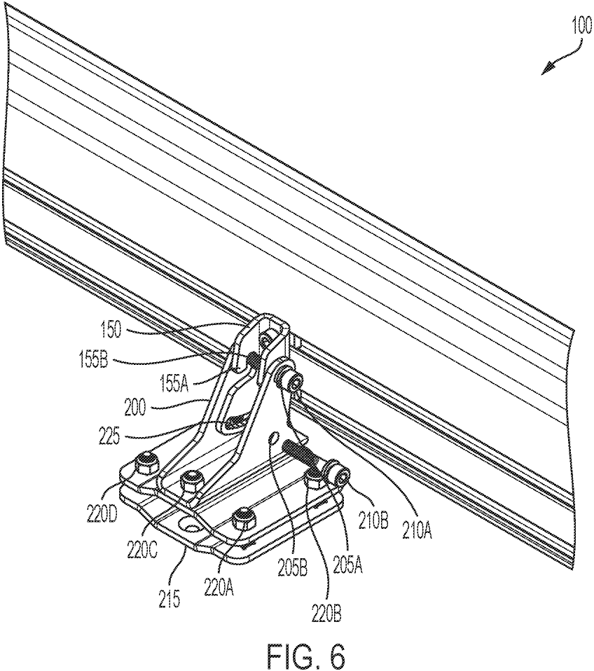

FIG. 6 illustrates an isometric view of the self-supporting awning 100 including a support mount 200. Support mount 200 may be implemented as either supporting mounts 200A or 200B, as shown in FIG. 5. As shown in FIG. 6, a supporting mount 150 may be attached to self-supporting awning 100. Supporting mount 150 may connect to support mount 200 by a hook 155a and recess 155B being inserted over a bolt, such as bolt 210A within hole 205A of support mount 200. At the same time, support mount 200 may further include a bolt hole 205B for bolt 210B on a first side of support mount 200 but may include an arcuate recess 225 on an opposing side of support mount 200. Bolt 210B may be installed with a nut or a threaded corresponding hole for bolt hole 205B. Bolt 210B may be used to fix an angle of support mount 200 and supporting mounts 150. For example, support mount 200 may allow adjustment of supporting mount 150 by allowing bolt 210B to maintain the position of self-supporting awning 100 at any particular angle as bolt 210B slides through arcuate recess 225. For example, if bolt 210B holds supporting mount 150 and support mount 200 at a first end of arcuate recess 225, self-supporting awning 100 may be disposed at an angle that is parallel to the mounting surface, or at an angle that is less than parallel. Alternatively, if bolt 210B holds supporting mount 150 and support mount 200 at a second end of arcuate recess 225, self-supporting awning 100 may be disposed at an angle that is above parallel to the mounting surface or at an angle that is higher than parallel. In other words, arcuate recess 225 allows adjustment of an angle of self-supporting awning 100. The degree of adjustment of the angle of the self-supporting awning, if parallel to the mounting surface is 0 degrees may be between -15 degrees and 65 degrees. In other words, self-supporting awning may be made to tip downwards during a rainstorm or upwards during early morning or late evening conditions or anywhere in between to provide desired shade by allowing bolt 210B to slide through arcuate recess 225.

Support member 200 may further include bolts 220A, 200B, 220C, and 200D which may be used to attach support member 200 to clamp 215. For support member 200 may be placed on, for example, a vehicle rack and attached to the vehicle rack by installing clamp 215 on a bottom of the vehicle rack and connecting support member 200 to clamp 215 by bolts 220A, 220B, 220C, and 220D. Bolts 220A-220D are merely explanatory. More or fewer bolts may be used to connect support member 200 to clamp 215.

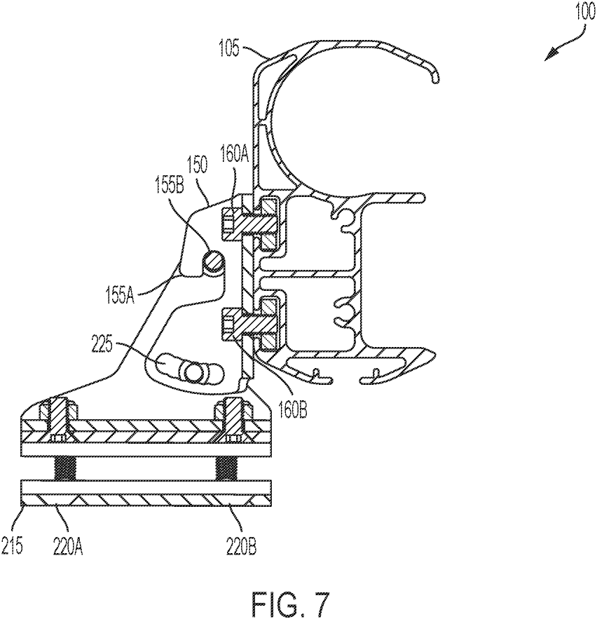

FIG. 7 illustrates a cross sectional view of the self-supporting awning assembly 100 and a support mount 200. As shown in FIG. 7, self-supporting awning 100 includes body 105. Body 105 may connect to supporting mount 150 by bolts, 160A and 160B which may thread into corresponding holes in body 105 or nuts contained within body 105 to secure supporting mount 150. Supporting mount 150 may connect to support mount 200 by a hook 155a and recess 155B being inserted over a bolt, such as bolt 210A within hole 205A of support mount 200, shown in FIG. 6. Hook 155A allows support mount 150 and body 105 (and consequently, self-supporting awning 100) to rotate on an axis defined by bolt 210A. For example, as arcuate recess 225 is adjusted to adjust an angle of body 105 and self-supporting awning 100, hook 155B may rotate around bolt 210A, for example, to accommodate a particular angle desired by a user. Clamp 215 is shown attached to support mount 200 by bolts 220A and 220B.

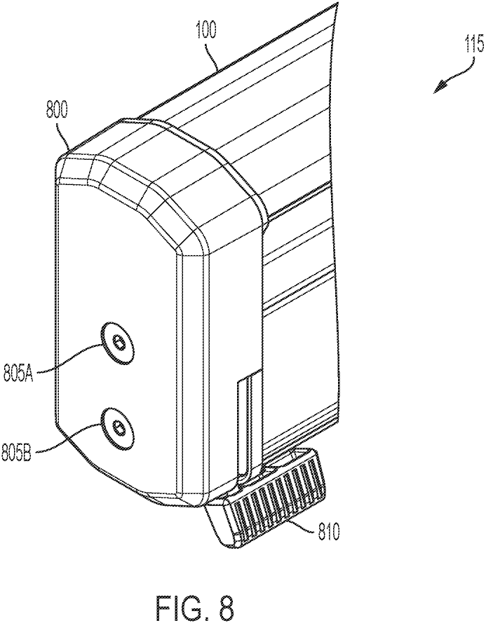

FIG. 8 illustrates an end 800 of self-supporting awning 100 and a tensioning and locking mechanism 115. Tensioning and locking mechanism 115 may be disposed at end 800 of self-supporting awning 100, shown in FIG. 1. End 800 may be implemented as an end cap 800 and be attached to self-supporting awning 100 by screws, such as screws 805A and 805B which attach end or end cap 800 to self-supporting awning 100. Further, a lever 810 may be provided which may be used to both tension awning 145, shown in FIG. 1, or to lock endbar 120 in place. For example, if self-supporting awning 100 is attached to a roof rack of a vehicle traveling down the road, lever 810 may lock endbar 120 in position so that awning 145 may not be inadvertently deployed. Lever 810 may further act as a tensioner which causes a slight retraction or reel force on awning 145 to tighten the awning as deployed. As shown in FIG. 8, endbar 120 is locked and lever 810 is in a locked position.

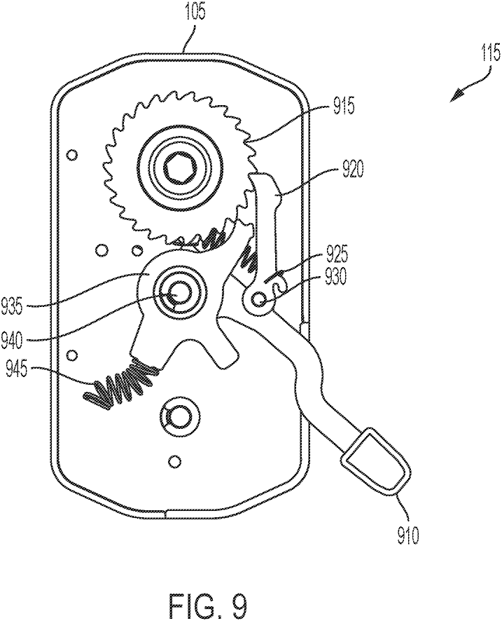

FIG. 9 illustrates a side view of the self-supporting awning 100 in a tensioning position with tensioning system 115 on body 105. Tensioning system may use lever 910 to apply tension to awning 145 as discussed above. Tensioning system 100 may include a main gear 915 which ratchets by a working pawl 920 which drives main gear 915 when lever 910 is pulled out and pushed in. Working pawl 920 may be connected to a spring 925 and to lever 910 by a pin 930. Tensioning system 115 may further include a secondary pawl 935 which holds main gear 915 in place while working pawl 920 ratchets down to a next gear tooth in main gear 915 in response to articulation of lever 910. Secondary pawl may be connected to body 105 by a bolt 940 and may be spring loaded by spring 945. In practice, lever 910 may drive working pawl to push a gear tooth on main gear 915. In response, secondary pawl may be driven by spring pressure from spring 945 into another gear tooth and support main gear 915 in a particular position while working pawl 920 re-orients to another gear tooth to continue driving main gear 915 to tension awning 145. Main gear 915 may be connected to reel system 110, which will be discussed below.

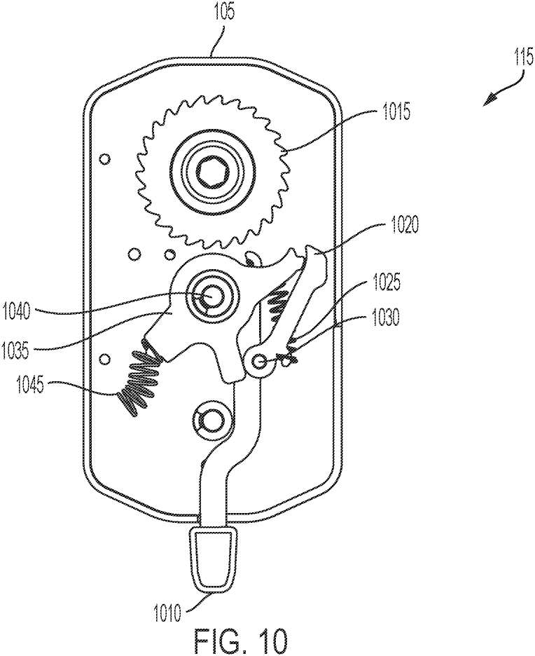

FIG. 10 illustrates a side view of a self-supporting awning tensioning mechanism 115 on body 105 in a locked position. As shown in FIG. 10, tensioning mechanism 1015 includes lever 1010 to apply tension to awning 145 as discussed above. Tensioning system 115 may include a main gear 1015. Tensioning system 115 further includes a working pawl 1020, a spring 1025, and a cross pin 1030 which attaches working pawl 1020 to lever 1010. Secondary pawl 1035 may be connected to body 105 by a bolt 1040 and may be spring loaded by spring 1045. As shown in FIG. 10, secondary pawl 1035 is interacting with working pawl 1020, due to lever 1010 being in a locked position to ensure that main gear 1015 maintains tension provided by reel system 110, which will be discussed below.

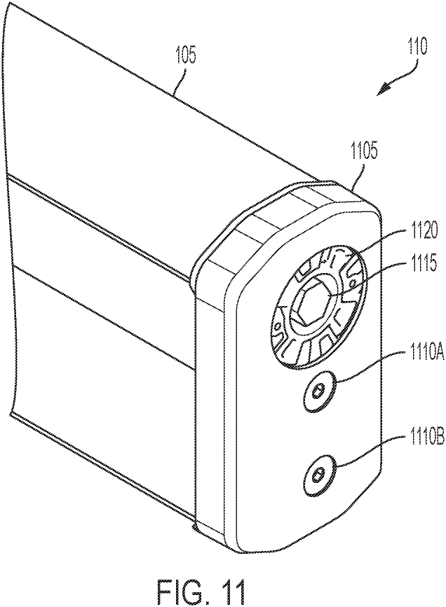

FIG. 11 illustrates an isometric view of another end of the self-supporting awning reel assembly 110. Reel assembly 110 may be installed within body 105 and be accessible to the outside through an endcap 1105. Endcap 1105 provides access to a reel controller 1120 installed within body 105 by a bolt 1115. Endcap 1105 may be secured to body 105 by screws, such as screws 1110A and 1110B. Reel controller 1120 may include one or more grooves for interacting with a tool, as desired, and may further be covered by a separate end plate which may cover reel 1120 controller 1120. Reel controller 1120 may serve to extend and retract awning 145, as will be discussed below.

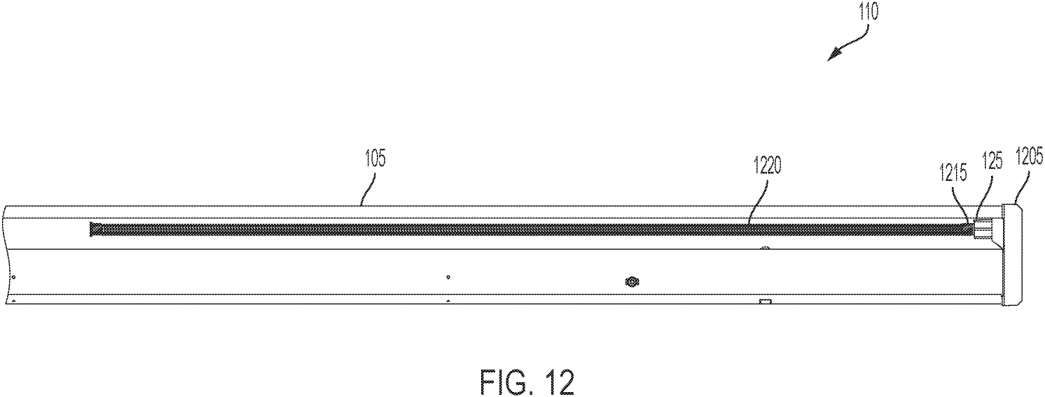

FIG. 12 illustrates a side view of a reel mechanism 110 within the self-supporting awning body 105. Reel mechanism 110 is illustrated having a reel interface 1205, which may be similar in implementation and description to end cap 1105 discussed above with respect to FIG. 11, which controls a reel 125. Reel 125 may include a reel tube 1215 which extends through body 105 of self-supporting awning 100. Reel 125 may be connected to a reel tube 1215. Reel tube 1215 may further include a spring 1220 which provides tortional force to reel 125.

When a user applies a force to endbar 120, awning 145, which may be connected directly to reel 125 by reel tube 1215, may be drawn out of body 105 and extend as shown in FIG. 3. As awning 145 is pulled out due to user force applied to endbar 120, spring 1220 may be loaded with tortional force which applies a force to endbar 120 via awning 145. Reel controller 1120, discussed above with respect to FIG. 11, may allow a user to manually retract awning 145 or providing a ratcheting stop that prevents force from spring 1220 from drawing awning 145 back into body 105 temporarily. When a user has finished using self-supporting awning 100, shown in FIG. 3, a user may pull slightly on endbar 120 and cause awning 145 to experience pressure from spring 1220 which retracts awning 145 back into body and rolls awning 145 around reel 125.

Similarly, when a user has deployed self-supporting awning 100, as shown in FIG. 3, awning 145 may not be held tightly between reel 125 and endbar 120. In this case, a user may manipulate lever 910 to slightly tighten awning 145 by pushing working pawl 920 against main gear 915 to cause reel 125 and reel tube 1215 to rotate and draw slack in awning 145 out of awning 145. In this manner, awning 145 may be tightened to prevent awning 145 from, for example, flapping in the breeze. The user may lock lever 910 in the locking position 1010 which ensures that the awning will be locked open and prevent reel 125 from opening or closing. When lever 910 is moved into an open position, a user may apply force to endbar 120 and close awning 145.

Unlike existing car awnings which require several separate procedures to deploy, the machine can be fully deployed in one procedure. This reduces setup and closing time from minutes to seconds, meeting the need for a quickly deployable car mounted awning which prior art did not meet. Advantages, features, and structure of the present disclosure will become better understood with reference to the following description and claims.

Although the present disclosure has been described in considerable detail with reference to certain preferred versions thereof, other versions are possible. Therefore, the spirit and scope of the appended claims should not be limited to the description of the preferred versions contained therein.

What is claimed is:

1. An awning, comprising:
an awning body, the awning body including:
a reel;
an awning cover;
a first swing arm;
a second swing arm; and
an endbar,
wherein the awning cover is selectively attached between the reel and the endbar when the endbar is extended away from the awning body by the first swing arm and the second swing arm such that the awning cover can be detached from the awning.

2. The awning of claim 1, wherein the awning body includes one or more supporting mounts.

3. The awning of claim 1, wherein the first swing arm and the second swing arm are connected to the awning body and the endbar.

4. The awning of claim 3, wherein the first swing arm and the second swing arm are connected to a side of the endbar that is opposite to the side of the awning body to which the first swingarm and the second swingarm are connected, respectively.

5. The awning of claim 4, wherein the first swing arm and the second swingarm cross each other at an angle relative to each other in an extended position.

6. The awning of claim 3, wherein the first swing arm and the second swing arm are telescoping.

7. The awning of claim 1, wherein the first swing arm and the second swing arm fold into the awning body when the endbar is not extended away from the awning body.

8. The awning of claim 1, wherein the first swing arm and the second swing arm are connected to the awning body and the endbar by pivotable connections.

9. The awning of claim 1, further comprising a support mount including an arcuate recess which adjusts an angle of the awning.

10. The awning of claim 1, wherein the awning cover is connected to the endbar and the reel assembly.

11. The awning of claim 10, wherein the reel includes a reel spring which applies torsion and retraction forces on the awning cover.

12. The awning of claim 10, wherein the awning further includes a locking lever.

13. The awning of claim 1, further comprising one or more support mounts connected to the supporting mounts on the awning body.

14. The awning of claim 1, wherein the first swing arm, the second swing arm, and the endbar support the awning canopy when the awning canopy is connected to the endbar and extended away from the awning body.

15. The awning of claim 1, wherein the awning cover is connected to the reel tube.

16. The awning of claim 1, further comprising a tensioning mechanism.

17. The awning of claim 16, where the tensioning mechanism includes a main gear and a working pawl driven by a lever.

18. The awning of claim 17, wherein the tensioning mechanism further includes a secondary pawl.

19. The awning of claim 1, wherein the reel includes a reel controller.

20. The awning of claim 19, wherein the reel controller is accessible through an endcap.
